(19) United States
(12) Patent Application Publication
(10) Pub. No.: US 2024/0246062 A1
(43) Pub. Date: Jul. 25, 2024

(54) PROCESS AND CIRCUIT FOR REINTERCALATING SPENT LITHIUM SELECTIVE ADSORBENTS

(71) Applicant: ILiAD IP COMPANY, LLC, Carlsbad, CA (US)

(72) Inventor: Charles R. Marston, Midland, MI (US)

(73) Assignee: ILiAD IP COMPANY, LLC, Carlsbad, CA (US)

(21) Appl. No.: 18/409,732

(22) Filed: Jan. 10, 2024

Related U.S. Application Data
(60) Provisional application No. 63/479,540, filed on Jan. 11, 2023.
(60) Provisional application No. 63/479,541, filed on Jan. 11, 2023.

(51) Int. Cl. B01J 20/34

(52) U.S. Cl. CPC B01J 20/3483; B01J 20/3433

(57) ABSTRACT

This invention generally relates to a process and circuit for reintercalating lithium aluminum double hydroxide (LADH) lithium selective adsorbents. The inventive process includes reintercalating the spent LADH adsorbent with lithium salt in a dilute brine under alkaline conditions at a predetermined intercalation temperature, followed by neutralization using an appropriate acid at a predetermined neutralization temperature. The inventive process can be performed to reintercalate the adsorbent and can be performed multiple times over the life of the adsorbent. The reintercalation process can be conducted at a chemical regeneration facility, or alternatively, in situ, such as at an on-site mineral extraction facility, in a mobile reinteractation circuit, or within adsorbent columns of a lithium extraction (e.g., DLE) circuit. In the later arrangement, the invention can be used in fixed beds, stirred tanks, pseudo- or simulated moving bed (SMB) circuits, or other DLE circuits.

### CROSS-REFERENCE TO RELATED APPLICATIONS

This application claims the benefit of U.S. Provisional Patent Application No. 63/479,540 filed on Jan. 11, 2023, and U.S. Provisional Patent Application No. 63/479,541 filed on Jan. 11, 2023, and incorporates by reference the provisional applications in their entirety into this document as if fully set out at this point.

### BACKGROUND OF THE INVENTION

### 1. Field of the Invention

The subject matter disclosed herein relates to a process and circuit for reintercalating spent lithium selective adsorbents and, more particularly, to an in situ process and circuit for reintercalating spent lithium aluminum double hydroxide (LADH) lithium selective adsorbents.

### 2. Description of the Related Art

The growing demand for lithium in various applications, particularly lithium-ion batteries, means that lithium-bearing solutions, brines, and other feedstocks are becoming increasingly attractive as new energy resources. Lithium-bearing solutions are expected to provide increasingly higher amounts of lithium to the battery metals market, particularly through new developments in direct lithium extraction (“DLE”) processes.

As lithium has gained importance for use in various applications, there are continuing efforts to develop simple, inexpensive, and efficient DLE processes for recovering lithium from lithum-containing solutions. There have been significant efforts in using layered lithium aluminates, typically of the formula LiX/Al(OH)₃. Unfortunately, proposed commercial designs for such processes generally employ large, packed columns using lithium aluminum double hydroxide (“LADH”) adsorbents, which selectively adsorb lithium ions from solutions at a moderate pH (e.g., 5-7), for lithium recovery. LADH adsorbents are sensitive to operating conditions and can be damaged by over-deintercalation or simply spent by usage or aging. These columns, therefore, suffer from several drawbacks, such as shortened lifetimes due to the gradual deterioration and disintegration of the particles and collapse of the crystal structures.

In the recovery of lithium from brines, the primary mode of aging, performance degradation, and failure of LADH adsorbents is via over-deintercalation, which occurs when the LADH adsorbent undergoes numerous adsorption/desorption cycles and/or extended deintercalation times or is deintercalated (or stripped) of lithium using a deintercalation solution having no, or too little, latent lithium (i.e., less than about 150 ppm). Over-deintercalation causes the LADH in the adsorbent to expel the lithium cation and its counterion from its characteristic layered structure, destroying the lithium adsorption site and the adsorbent's ability to rapidly intercalate and elute lithium salts with high selectivity. It has been found that spent, aged, or damaged LADH adsorbents were final and irreversible, limiting the useful lifetime of LADH adsorbents and making many LADH adsorbents non-economic media for commercial lithium recovery.

### SUMMARY OF THE INVENTION

Accordingly, it is an object of this invention to provide a process and circuit that quickly and efficiently reintercalates spent lithium selective adsorbents.

The invention provides a process that quickly and efficiently reconverts the LADH degradation product, crystalline aluminum trihydroxides (Al(OH)₃), back to LADH by regenerating or reintercalating spent, aged, or damaged LADH adsorbents with a stoichiometric excess or a stoichiometric amount of lithium salt in a dilute brine with alkaline conditions at a predetermined intercalation temperature, followed by neutralization using an appropriate acid at a predetermined neutralization temperature.

The invention further provides a process and circuit for in situ reintercalation of spent lithium selective adsorbents containing LADH. At the commercial scale, without regenerating and reusing the lithium selective adsorbents in subsequent intercalations, the useful lifetime of the LADH adsorbents is limited. The loss of spent, aged, or damaged lithium selective adsorbent could be non-economical, and waste management could be costly. The inventive in situ reintercalation process and circuit eliminate downtime and reduce the cost associated with unloading and reloading lithium selective adsorbents for offsite regeneration.

In general, in a first aspect, the invention relates to a process for reintercalating a spent lithium selective adsorbent. The process includes intercalating an initial quantity of the spent lithium selective adsorbent with lithium under alkaline conditions at a predetermined intercalation temperature using a pre-intercalation reaction volume of an intercalation reaction liquor to produce an intercalated layered aluminate adsorbent and a post-intercalation reaction volume of a partially depleted intercalation reaction liquor. The intercalated layered aluminate adsorbent is neutralized under acidic conditions at a predetermined neutralization temperature to produce a reintercalated lithium selective adsorbent.

In an embodiment, the intercalation temperature can be between about 25° C. and about 125° C. (and any range or value therebetween), and more particularly, between about 85° C. and about 105° C. or greater than 100° C. to about 105° C.

In an embodiment, the alkaline conditions can have a pH from about 7 to about 13 (and any range or value therebetween), and more particularly, between about 9 and about 12.

In an embodiment, the intercalation reaction liquor can include a lithium salt and an alkali in a dilute brine.

In an embodiment, the lithium salt can be LiCl, LiNO₃, LiBr, LiOH, or a mixture thereof, and more particularly, the lithium salt can be LiCl or LiOH.

In an embodiment, the lithium salt in the intercalation reaction liquor can have a concentration ratio of about 1:1 to about 5:1 Li to Al.

In an embodiment, the alkali can be an alkali hydroxide, an alkaline earth metal hydroxide, a strong base, a monoacid base, ammonia, or a mixture thereof. The alkali can be KOH, NaOH, LiOH, or a mixture thereof, and more particularly, the alkali can be NaOH or LiOH. The alkali can have a concentration between about 1 and about 3 mol of the alkali per mol of Al(OH)₃ in the adsorbent (and any range or value therebetween), and more particularly, greater than 1 to about 3 mol of the alkali per mol of Al(OH)₃ in the intercalated layered aluminate adsorbent, or more particularly, about 1 to 1.5 mol of the alkali per mol of Al(OH)₃ in the adsorbent, and more particularly, greater than 1 to about 1.5 mol of the alkali per mol of Al(OH)₃ in the intercalated layered aluminate adsorbent.

In an embodiment, the lithium salt can be LiOH, and the alkali can be LiOH.

In an embodiment, the brine contains a majority of chloride salts, and can be NaCl, NaBr, NaNO3, KCl, KBr, or a mixture thereof.

In an embodiment, the brine can be NaCl, the lithium salt can be LiCl, and the alkali can be NaOH.

In an embodiment, the brine can be KCl, the lithium salt can be LiOH, and the alkali can be LiOH.

In an embodiment, the step of intercalating the initial quantity of the spent lithium selective adsorbent can also include intercalating the initial quantity of the spent lithium selective adsorbent by heating to the predetermined intercalation temperature for a predetermined amount of intercalation time. The predetermined amount of intercalation time can be between about 0.375 hours and about 390 hours (and any range or value therebetween), and more particularly, greater than 100 hours to about 390 hours, and more particularly, between about 1.5 hours and about 6 hours.

In an embodiment, the neutralization temperature can be between about 25° C. and about 115° C. (and any range or value therebetween), and more particularly, between about 65° C. and about 80° C., and more particularly, greater than 70° C. to about 80° C.

In an embodiment, the step of intercalating the initial quantity of the spent lithium selective adsorbent can also include intercalating the initial quantity of the spent lithium selective adsorbent under acidic conditions. The acidic conditions can have a pH from about 4.5 to about 7 (and any range or value therebetween), and more particularly, between about 5 and about 5.8, and more particularly, greater than 5 to about 5.8.

In an embodiment, the acid can be a strong acid, a mineral acid, a sulfonic acid, a carboxylic acid, or a mixture thereof. The acid can be hydrochloric acid, sulfuric acid, nitric acid, phosphoric acid, hydrobromic acid, perchloric acid, formic acid, acetic acid, or a mixture thereof, and more particularly, the acid can be acetic acid. The acid can have a concentration of between about 5% and about 100% (and any range or value therebetween).

In an embodiment, the step of neutralizing the intercalated layered aluminate adsorbent can include neutralizing the intercalated layered aluminate adsorbent for a predetermined amount of neutralization time.

In an embodiment, the predetermined amount of neutralization time can be between about 0.03125 hours and about 16 hours (and any range or value therebetween), and more particularly, between about 0.25 hours and about 1 hours, or more particularly less than 2 hours.

In an embodiment, the process further includes intercalating the initial quantity of the spent lithium selective adsorbent with the lithium under the alkaline conditions at the predetermined intercalation temperature using the pre-intercalation reaction volume of the intercalation reaction liquor to produce the intercalated layered aluminate adsorbent and the post-intercalation reaction volume of the partially depleted intercalation reaction liquor. The post-intercalation reaction volume of the partially depleted intercalation reaction liquor is decanted from the intercalated layered aluminate adsorbent to obtain a decanted intercalation reaction liquor, and the intercalated layered aluminate adsorbent is neutralized under the acidic conditions at the predetermined neutralization temperature to produce the lithium selective adsorbent. The decanted intercalation reaction liquor is augmented by adding an makeup volume to reconstitute the pre-intercalation reaction volume and obtain an augmented intercalation reaction liquor, and the augmented intercalation reaction liquor is recycled for intercalating a subsequent quantity of the spent lithium selective adsorbent according to step a.

In an embodiment, the makeup volume can include a makeup brine, a makeup lithium salt, a makeup alkali, or a mixture thereof.

In an embodiment, the makeup brine can be NaCl, NaBr, NaNO₃, KCl, KBr, or a mixture thereof.

In an embodiment, the makeup lithium salt can be LiCl, LiNO₃, LiBr, LiOH, or a mixture thereof.

In an embodiment, the makeup alkali can be KOH, NaOH, LiOH, or a mixture thereof.

In an embodiment, the makeup lithium salt can be LiOH, and the makeup alkali can be LiOH.

In an embodiment, the makeup brine can be NaCl, the makeup lithium salt can be LiCl, and the makeup alkali can be NaOH.

In an embodiment, the makeup brine can be KCl, the makeup lithium salt can be LiOH, and the makeup alkali can be LiOH.

In an embodiment, the step of recycling the augmented intercalation liquor can include filtering the augmented intercalation reaction liquor.

In an embodiment, the steps of intercalating, decanting, neutralizing, augmenting, and recycling are successfully repeated until the intercalation reaction liquor can be fully depleted or contains excess residual alumina such that the reaction no longer produces high-quality LADH adsorbents. The steps of intercalating, decanting, neutralizing, augmenting, and recycling can be successfully repeated up to about seven times, more particularly, up to about five times, and more particularly, up to about three times.

In general, in a second aspect, the invention relates to a process for in situ reintercalation of a spent lithium selective adsorbent. The process includes the steps of:
a. positioning one or more adsorbent beds or columns having the spent lithium selective adsorbent at an adsorption loading zone;
b. passing an activation liquor solution through the adsorption loading zone;
c. positioning the one or more adsorbent beds or columns at a lithium product strip zone; and
d. passing a neutralization liquor solution through the lithium product strip zone.

In an embodiment, the process can be performed for a predetermined amount of reintercalation time at a predetermined reintercalation temperature and under alkaline conditions. The predetermined amount of regeneration time may range between about 10 hours and about 12 hours, the predetermined regeneration temperature may be between about 65° C. and about 75° C., and pH for the alkaline conditions may range between about 5.4 and about 9.6. The predetermined amount of regeneration time may be divided into a predetermined number of steps.

In an embodiment, the activation liquor solution includes lithium salt in a brine, wherein the lithium salt can be LiCl, LiNO₃, LiBr, LiOH, LiI, Li₂SO₄, or a mixture thereof. In an embodiment, the brine includes NaCl, NaBr, NaNO₃, KCl, KBr, or a mixture thereof. In an embodiment, the lithium salt includes a mixture of LiOH and LiCl, and the brine can be NaCl.

In an embodiment, step a. of passing the activation liquor solution through the adsorption loading zone can be accomplished using a process brine feed pump.

In an embodiment, the process further involves combining between about 4,000 and about 6,000 mg/kg of lithium salt with about 50,000 gallons of brine to obtain the activation liquor solution.

In general, in a third aspect, the invention relates to a process for in situ regeneration of a spent lithium selective adsorbent. The process involves intercalating one or more adsorbent beds or columns having the spent lithium selective adsorbent at an adsorption loading zone (step a.). The process also involves neutralizing the one or more adsorbent beds or columns at a lithium product strip zone (step b.).

In an embodiment, step a. of the process involves isolating the adsorption loading zone from an upstream combined feedstock vessel and from a downstream depleted raffinate vessel.

In an embodiment, step a. of the process involves introducing an activation liquor solution at the adsorption loading zone, where the activation liquor solution includes lithium salt and brine. The lithium salt may be LiCl, LiNO₃, LiBr, LiOH, LiI, Li₂SO₄, or a mixture thereof. The brine optionally contains a majority of chloride salts. The brine may include NaCl, NaBr, NaNO₃, KCl, KBr, or a mixture thereof. In an embodiment, the lithium salt includes a mixture of LiOH and LiCl, and the brine can be NaCl.

In an embodiment, a raffinate portion that can be obtained from the adsorption loading zone supplies the brine for the activation liquor solution.

In an embodiment, a rerouted fraction that can be obtained from a displacement zone supplies the brine for the activation liquor solution.

In an embodiment, an activation liquor makeup supplies the lithium salt for the activation liquor solution. The activation liquor makeup may optionally supply the brine for the activation liquor solution. In an embodiment, the activation liquor makeup can be obtained by combining a reagent solution having the lithium salt with a brine solution having the brine.

In an embodiment, the activation liquor makeup includes a pH modifier, where the pH modifier can be HCl.

In an embodiment, the process further involves removing the activation liquor solution from the adsorption loading zone, isolating a lithium-depleted brine from the activation liquor solution for disposal, and storing a recirculated reagent from the activation liquor solution for reuse.

In an embodiment, step a. of the process involves isolating the adsorption loading zone from an upstream combined feedstock vessel and from a downstream depleted raffinate vessel.

In an embodiment, step b. of the process further involves introducing a neutralization liquor solution at the lithium product strip zone. The neutralization liquor solution may include an acid. Suitable acids can be hydrochloric acid, sulfuric acid, nitric acid, phosphoric acid, hydrobromic acid, perchloric acid, formic acid, acetic acid, or a mixture thereof. In an embodiment, the acid can be acetic acid. The neutralization liquor solution may include a brine. In an embodiment, the brine contains a majority of chloride salts. In an embodiment, brine includes NaCl, NaBr, NaNO₃, KCl, KBr, or a mixture thereof. In an embodiment, a latent eluate solution that can be obtained from the strip displacement zone supplies the brine for the neutralization liquor solution. In an embodiment, a second raffinate portion that can be obtained from the adsorption loading zone supplies the brine for the neutralization liquor solution. In an embodiment, a spent neutralization liquor that can be obtained from a previous neutralization step supplies the brine for the neutralization liquor solution.

In an embodiment, step b. of the process further involves isolating the lithium product strip zone from an upstream lithium product strip vessel and from a downstream lithium product vessel.

In an embodiment, steps a. and b. of the process are repeated until the spent lithium selective adsorbent of the one or more adsorbent beds or columns can be completely or almost completely regenerated.

In an embodiment, step a. and step b. of the process are performed for a predetermined amount of regeneration time at a predetermined regeneration temperature and under alkaline conditions. The predetermined amount of regeneration time may range between about 10 hours and about 12 hours, the predetermined regeneration temperature may be between about 65° C. and about 75° C., and pH for the alkaline conditions may ranges between about 5.4 and about 9.6.

In general, in a fourth aspect, the invention relates to a circuit for in situ reintercalation of a spent lithium selective adsorbent. The circuit includes a reagent vessel having a reagent solution that includes a lithium salt, a brine vessel having a brine solution, a simulated moving bed (“SMB”), and a process pump configured to pump the reagent solution, the brine solution, or both to the SMB circuit. The SMB circuit includes an activation stage having an adsorption loading zone and a neutralization stage having a lithium product strip zone, where one or more adsorbent beds or columns having the spent lithium selective adsorbent cycle through the adsorption loading zone and the lithium product strip zone.

In an embodiment, the lithium salt can be LiCl, LiNO₃, LiBr, LiOH, LiI, Li₂SO₄, or a mixture thereof.

In an embodiment, the brine solution contains a majority of chloride salts.

In an embodiment, the brine includes NaCl, NaBr, NaNO₃, KCl, KBr, or a mixture thereof.

In an embodiment, a plurality of check valves control fluid flow from the reagent vessel, the brine vessel, or both.

In an embodiment, the reagent solution and the brine solution are combined to form an activation liquor makeup upstream from the process pump.

In an embodiment, the system includes a heat exchanger upstream of the SMB circuit, where the heat exchanger provides temperature control for the activation liquor makeup.

In an embodiment, the SMB circuit further includes an activation liquor vessel upstream from the adsorption loading zone.

In an embodiment, the process pump moves the activation liquor makeup into the activation liquor vessel and through the adsorption loading zone.

In an embodiment, the SMB circuit includes a neutralization liquor vessel upstream from the lithium product strip zone, where the neutralization liquor vessel contains a neutralization liquor solution. The neutralization liquor solution can include an acid, where the acid can be hydrochloric acid, sulfuric acid, nitric acid, phosphoric acid, hydrobromic acid, perchloric acid, formic acid, acetic acid, or a mixture thereof.

In an embodiment, the SMB circuit can be a continuous countercurrent adsorption and desorption (“CCAD”) circuit.

### BRIEF DESCRIPTION OF THE DRAWINGS

The above and other objects and advantages of this invention may be more clearly seen when viewed in conjunction with the accompanying drawing wherein:

FIGS. 1A and 1B are X-ray diffraction (XRD) images of 2-Theta (θ) traces of lithium selective adsorbent for the Gibbsite precursor forms (1A) and the LADH form (1B).

FIG. 2 is an XRD image of 2-Theta (θ) traces of a regenerated lithium selective adsorbent with low Gibbsite and high LADH, a completely deintercalated lithium selective adsorbent with high Gibbsite and no LADH, and a new lithium selective adsorbent with low Gibbsite and high LADH.

FIG. 3 is a process flow diagram for an exemplary process for reintercalating spent LADH lithium selective adsorbent in accordance with an illustrative embodiment of the invention disclosed herein.

FIG. 4 is a process flow diagram for another exemplary process for reintercalating spent LADH lithium selective adsorbent by recycling and augmenting an intercalation reaction liquor in accordance with another illustrative embodiment of the invention disclosed herein.

FIG. 5 is a schematic diagram of an example of an in situ intercalation circuit for reintercalating a LADH lithium selective adsorbent in accordance with an illustrative embodiment of the invention disclosed herein.

FIG. 6 is a process flow diagram of an in situ reintercalation process and circuit within a continuous countercurrent adsorption and desorption process/circuit for lithium recovery in accordance with an illustrative embodiment of the invention disclosed herein.

FIG. 7 is a flow diagram for an in situ reintercalation process according to an illustrative embodiment of the invention disclosed herein.

FIG. 8 graphically illustrates LADH adsorbent forced degradation and subsequent regeneration according to an illustrative embodiment of the invention disclosed herein.

FIG. 9 graphically illustrates LADH adsorbent performance with successive lithium chloride recycles according to an illustrative embodiment of the invention disclosed herein.

FIG. 10 graphically illustrates the lithium chloride savings provided by an illustrative embodiment of the invention disclosed herein.

FIG. 11 graphically illustrates LADH adsorbent unintentional degradation and subsequent regeneration according to an illustrative embodiment of the invention disclosed herein.

### DETAILED DESCRIPTION OF THE INVENTION

While this invention is susceptible to embodiment in many different forms, there are shown in the drawings and will herein be described hereinafter in detail some specific embodiments of the invention. It should be understood, however, that the present disclosure is to be considered an exemplification of the principles of the invention and is not intended to limit the invention to the specific embodiments so described.

The invention disclosed herein is directed to a process for reintercalating spent (e.g., deintercalated) lithium selective adsorbents. The inventive process described herein can be performed to reintercalate the adsorbent and can be performed multiple times over the life of the adsorbent. The reintercalation process can be conducted at a chemical regeneration facility, or alternatively, in situ, such as at an on-site mineral extraction facility, in a mobile reinteractation circuit, or within adsorbent columns of a lithium extraction (e.g., DLE) circuit. In the later arrangement, this invention can be used in fixed beds, stirred tanks, pseudo- or simulated moving bed (SMB) circuits, or other DLE circuits (including continuous countercurrent adsorption and desorption circuits having rotary or indexing multi-port valve systems) and may take advantage of existing piping and pump arrangements. Depending on the properties of the brine solution being processed, mobile or dedicated reagent tanks may be added to the existing infrastructure in various embodiments.

The lithium selective adsorbent has an inorganic composition. The term “inorganic,” as used herein, refers to those compositions not containing carbon or wherein carbon is present but in its elemental state. Typically, the inorganic composition includes at least one metal, wherein the term “metal,” as used herein, includes traditionally defined metals as well as metalloids (those elements having both metallic and non-metallic properties and which overlap with the main group elements). The inorganic composition can be or can include a metal oxide composition, such as silica, Gibbsite (and its common polymorphs, Boehmite, Nordstrandite, bayerite), alumina, (e.g., alumina, θ-Al₂O₃, χ-Al₂O₃, κ-Al₂O₃, ε-Al₂O₃, δ-Al₂O₃, AlO(OH), pseudoboehmite, or a combination thereof) or an aluminosilicate, such as a zeolite, e.g., MFI-type, MEL-type, MTW-type, MCM-type, BEA-type, faujasite, or ZSM-type zeolites. The metal oxide composition may alternatively be or include, for example, zirconium oxide, yttrium oxide, titanium oxide, cerium oxide, chromium oxide, copper oxide, nickel oxide, or hafnium oxide, or a combination thereof.

The inorganic composition can include a metal carbide composition, such as silicon carbide, iron carbide (e.g., steel), tungsten carbide, titanium carbide, molybdenum carbide, or boron carbide, or combination thereof.

The inorganic composition can include a metal nitride composition, such as boron nitride, silicon nitride, silicon oxynitride, silicon carbide nitride, aluminum nitride, tantalum nitride, or zirconium nitride, or combination thereof. Alternatively, the inorganic composition can include a metal boride composition, such as aluminum boride, titanium boride, cobalt boride, tantalum boride, or magnesium boride, or combination thereof. The inorganic composition can also include a ceramic composition, which may be an oxide, carbide, nitride, or boride material.

The support for the lithium selective adsorbent can be a polymer, for example, a polyimide, polyether ether ketone (PEEK), polybenzimidazole, ionomer (e.g., sulfonated tetrafluoroethylene, such as Nafion®), polysiloxane (e.g., a silicone rubber or foam), polyurethane, polycarbonate, polyethyleneimine (PEI), polyester (e.g., polyethylene terephthalate), polyamide (e.g., a nylon), vinyl addition polymer (e.g., polyvinylchloride, polyethylene, polypropylene, polystyrene or a fluoropolymer, such as PVDF or PTFE), a mixture of polymers or a copolymer that includes one or more of any of the foregoing polymers. The polymer may alternatively be a composite that includes at least one of the foregoing polymers, wherein the composite includes separate regions (e.g., layers) of polymers of different compositions. The polymer may alternatively be an ion exchange resin bead or particle.

As used herein, the lithium selective adsorbent can have any of the lithium aluminum intercalate LADH forms known in the art, such as lithium aluminum layered double hydroxide chloride (LiCl·2Al(OH)₃), Gibbsite-based (or Gibbsite's common polymorphs, e.g., Bayerite, Boehmite, and Nordstrandite) lithium aluminum layered double hydroxide, lithium aluminum intercalate (LiAl₂(OH)₆Cl) crystals in macroporous, polymeric resin beads or other suitable adsorbent support noted above. As used herein, all references to Gibbsite include its common polymorphs Bayerite, Boehmite, and Nordstrandite. Equation 1 demonstrates an exemplary intercalation reaction to produce LADH from Gibbsite.

$${L}_{n} X + {2}_{n} {Al ( OH )}_{3} + p {H}_{2} O = {[ {{LiAl}_{2} ( OH )}_{6} ]}_{n} X \cdot p {H}_{2} O ( LADH - X ) \\ where X = {Cl}^{-} , {Br}^{-} , {I}^{-} , {SO}_{4}^{2 -} , {NO}_{3}^{-} \qquad ( Equation 1 )$$

Generally, LADH lithium selective adsorbents are manufactured from microcrystalline, hydrated aluminum trihydroxides (Al(OH)₃) (e.g., Gibbsite) by heating the hydrated alumina precursor with one or more lithium salts at an elevated pH using alkali chemicals, such as hydroxide salts of sodium, lithium, or potassium.

As noted above, the primary mode of aging, performance degradation, and failure of LADH adsorbents is via complete deintercalation or over-stripping, which occurs when the LADH adsorbent undergoes numerous adsorption/desorption cycles, extended deintercalation times, or is deintercalated of lithium using a deintercalation solution having no, or too little, latent lithium (i.e., less than about 150 ppm). Complete deintercalation or over-stripping causes the LADH in the adsorbent to expel the lithium cation and its counterion from its characteristic layered structure, destroying the lithium adsorption site and the adsorbent's ability to rapidly intercalate and elute lithium salts with high selectivity. An exemplary embodiment of this intercalation reaction is outlined in Equation 2.

$${[ {{LiAl}_{2} ( OH )}_{6} ]}_{n} X \cdot p {H}_{2} O + aq \to 2 n {Al ( OH )}_{3} + {Li}_{n} X \qquad ( Equation 2 )$$

As used herein, “spent” includes deintercalated, aged, damaged, degraded, depleted, exhausted, or otherwise over-stripped lithium selective adsorbents, and “reintercalating” includes regenerating, rejuvenating, reconditioning, renovating, repairing, or otherwise intercalating spent lithium selective adsorbents.

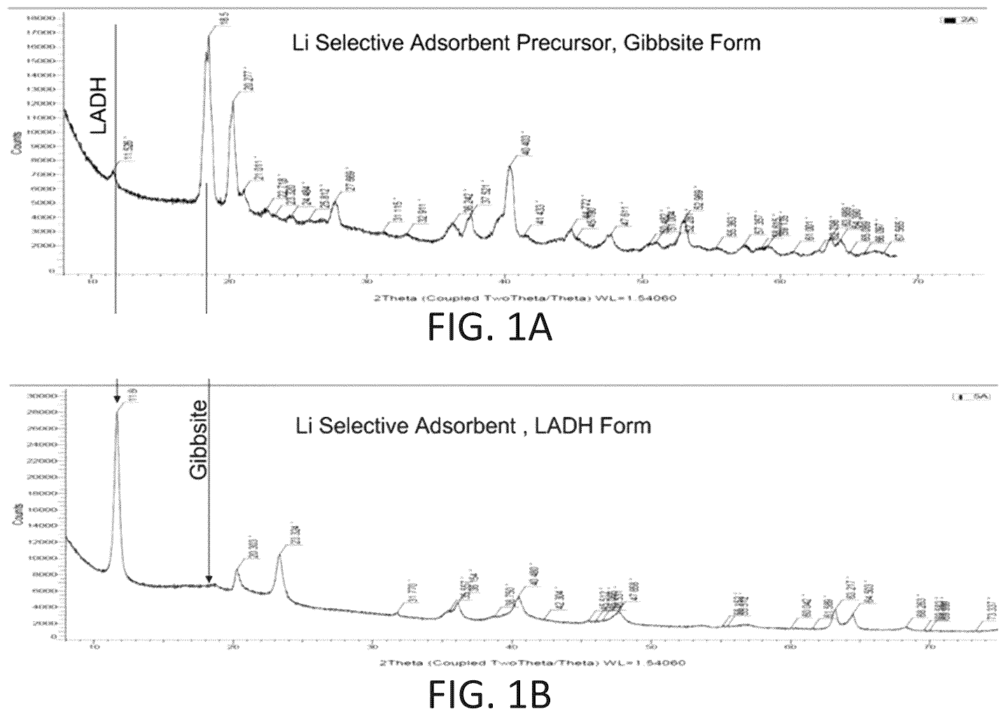

Spectroscopic analysis by X-Ray Diffraction (XRD) clearly shows that the primary mode of aging and deintercalation of LADH is the collapse of the LADH structure to Gibbsite. As shown in FIG. 1, several peaks in the 2 Theta° XRD spectra of LADH adsorbents are diagnostic for the presence of LADH and Gibbsite, and when the adsorbent is completely deintercalated, the LADH peaks at 11.5° and 23.1° (FIG. 1A) diminish while the Gibbsite peak rises at 18.5° (FIG. 1B). During the conversion of LADH to Gibbsite, almost no aluminum is lost.

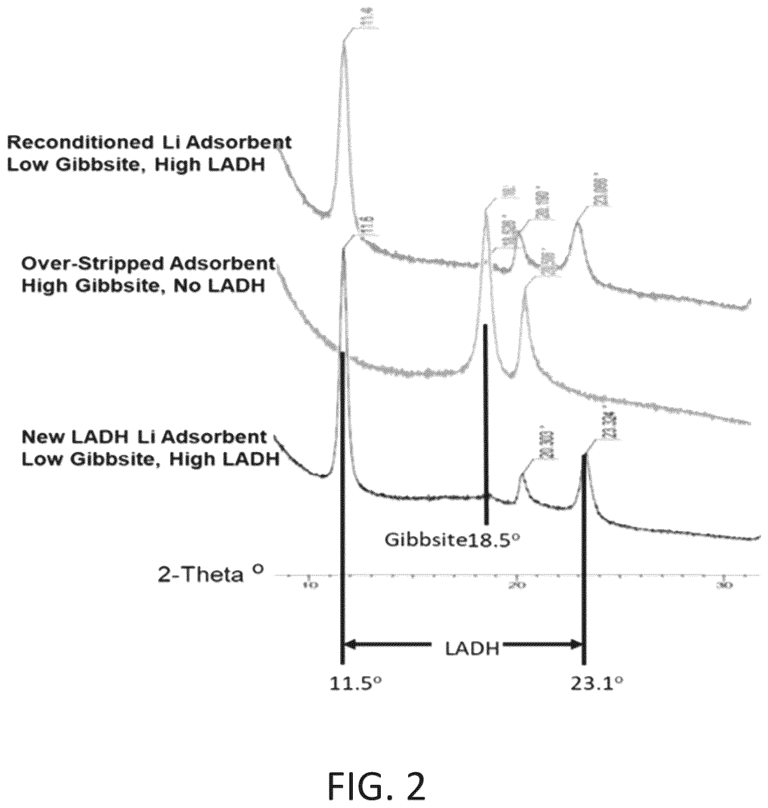

The invention disclosed herein is directed to a process and circuit for reintercalating spent lithium selective adsorbents containing LADH to a like-new condition with original strength and properties, namely a fully reintercalated state, exhibiting lithium selectivity and capacity similar to, or greater than, freshly prepared adsorbent prepared from virgin source materials (see FIG. 2). The inventive process quickly and efficiently reconverts the Gibbsite degraded product back to LADH by heating the spent adsorbent at a predetermined temperature in the presence of lithium salts under alkaline conditions for a predetermined amount of time. The reintercalation process can be performed with either a stoichiometric excess or a stoichiometric amount of lithium salt in a dilute brine to drive the reaction forming LADH from Gibbsite. With the increasing value of lithium in the marketplace and the drive toward zero discharge at production facilities, the inventive process can further include recycling the reaction intercalation liquor for reintercalating subsequent quantities of spent LADH adsorbent.

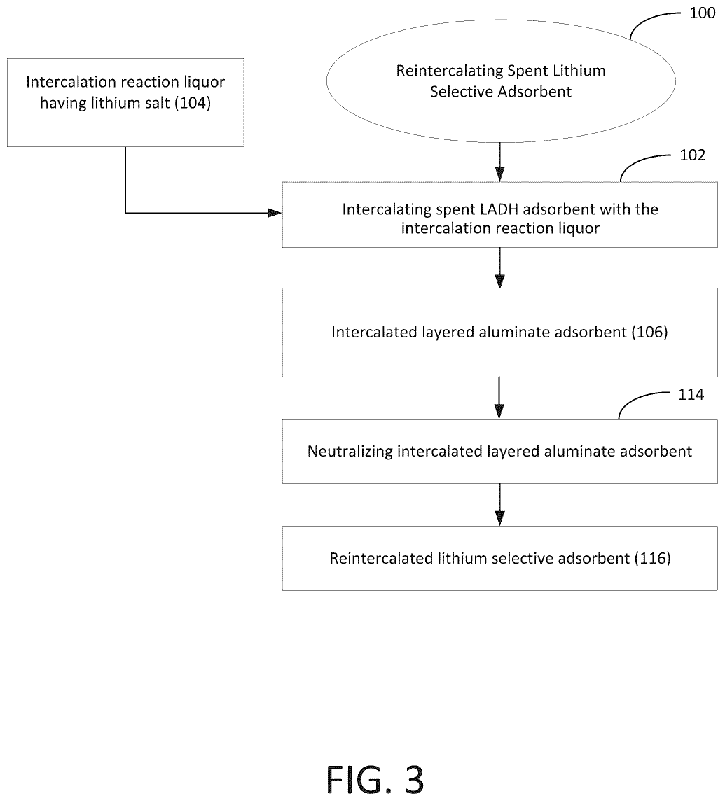

FIG. 3 illustrates an exemplary process flow diagram for the inventive regeneration or reintercalation process 100. As shown in Equation 2 above, spent lithium selective adsorbent (LADH) is generally deintercalated to aluminum trihydroxide (e.g., Gibbsite). In the reintercalating step 102 of the inventive reintercalation process 100, aluminum trihydroxide of the spent lithium selective adsorbent is converted back to LADH by reacting the Al(OH)₃ loaded resin support with lithium salt in a dilute brine under alkaline conditions at a predetermined intercalation temperature. In one embodiment, the adsorbent precursor spent LADH lithium selective adsorbent is intercalated by heating to the predetermined intercalation temperature in the presence of the lithium salt in the brine under the alkaline conditions for a predetermined amount of intercalation time. In step 104, the layered aluminate adsorbent is neutralized with an acid to obtain the reintercalated lithium selective adsorbent.

The lithium in the intercalation reaction liquor 104 may include lithium from the lithium salt, the alkali, or both. The lithium salt can be LiCl, LiBr, LiI, LiOH, Li₂SO₄, Li₂CO₃, LiNO₃, or a mixture thereof. The lithium in the intercalation reaction liquor 104 can have a ratio with aluminum ranging from about 1:1 to about 5:1 Li to Al (and any range or value therebetween).

For the alkaline conditions of step 102, the alkali in the intercalation reaction liquor 104 yields an alkaline pH from about 7 to about 13 (and any range or value therebetween), and more particularly, a pH between about 9 and about 12. Suitable alkalis include alkali hydroxides, alkaline earth metal hydroxides, strong bases, monoacid bases, ammonia, and mixtures of the same. Without limitation, the alkali can be hydroxides of potassium (KOH), sodium (NaOH), lithium (LiOH), or of other alkali or alkaline earth metals, other suitable strong or monoacid bases, ammonia (potentially from urea thermal decomposition), or a mixture thereof. Due to the elevated charge of LiOH, the use of LiOH as the source of alkali provides more alkalinity than is normally applied during the lithium intercalation reaction as aluminum hydroxide compounds are transformed to LADH. The alkali concentration can be between about 1 to about 3 mol of the alkali per mol of Al(OH)₃ in the reintercalated layered aluminate adsorbent (and any range or value therebetween), and more particularly, greater than 1 to about 3 mol of the alkali per mol of Al(OH)₃ in the reintercalated layered aluminate adsorbent, or more particularly, about 1 to 1.5 mol of the alkali per mol of Al(OH)₃ in the reintercalated layered aluminate adsorbent, being processed, more particularly, greater than 1 to about 1.5 mol of the alkali per mol of Al(OH)₃ in the reintercalated layered aluminate adsorbent.

The dilute brine used for intercalation in step 102 can be NaCl, NaBr, NaNO₃, KCl, KBr, or a mixture thereof, and other dilute brines preferably containing a majority of chloride salts. In one non-limiting embodiment, the lithium salt includes LiOH, the alkali includes NaOH, and the dilute brine includes NaCl; in this embodiment, the lithium salt contributes to the stoichiometric amount of lithium but the alkali does not. In another non-limiting embodiment, the dilute brine includes KCl, NaCl, or both, while the lithium salt and the alkali are both LiOH; in this embodiment, both the lithium salt and the alkali contribute to the stoichiometric amount of lithium in step 102.

The predetermined intercalation temperature for step 102 can be between about 25° C. and about 125° C. (and any range or value therebetween, including without limitation the values shown in Table 2 and the ranges therebetween), and more particularly, between about 85° C. and about 105° C. In one non-limiting embodiment, the intercalation temperature is greater than 100° C. to about 105° C. As shown in Table 1, depending upon the intercalation temperature, the intercalation time can be between about 0.375 hours and about 390 hours (and any range or value therebetween, including without limitation the values shown in Table 1 and the ranges therebetween), more particularly, between about 0.75 hours and about 390 hours, and more particularly, about 1.5 hours to about 6 hours. In one embodiment, the intercalation time is greater than 100 hours to about 390 hours.

TABLE 1
Intercalation Time and Temperatures.

| | Temperature (° C.) | | | | | | | | | | |
|---|---|---|---|---|---|---|---|---|---|---|---|
| | 125 | 115 | 105 | 95 | 85 | 75 | 65 | 55 | 45 | 35 | 25 |
| Time | 0.375 | 0.75 | 1.5 | 3 | 6 | 12 | 24 | 48 | 96 | 192 | 390 |
| (Hours) | | | | | | | | | | | |

Turning back to FIG. 2, the resulting products of the intercalating step 102 include a post-intercalation reaction volume of a partially depleted intercalation reaction liquor 108 and an intercalated layered aluminate adsorbent 106, which is neutralized (step 114) under acidic conditions to an acidic pH of about 4.5 and about 7 (and any range or value therebetween), and more particularly, a pH between about 5.4 and about 6.5 or a pH between about 5 and about 5.8, more particularly a pH greater than 5 to about 5.8. The intercalated layered aluminate adsorbent 106 is neutralized using an acid at a predetermined neutralization temperature to produce the reintercalated lithium selective adsorbent 116. The acid can be hydrochloric, sulfuric, nitric, phosphoric, hydrobromic, perchloric, formic, acetic, or other suitable strong, mineral, sulfonic, or carboxylic acids, or a mixture thereof. The acid can have a concentration of between about 5% and about 100% (and any range or value therebetween).

As shown by Table 2, the neutralization temperature for step 114 can range from about 25° ° C. to about 115° C. (and any range or value therebetween, including without limitation the values shown in Table 3 and the ranges therebetween), and more particularly, from between about 65° C. and about 80° C. In one embodiment, the neutralization temperature is greater than 70° ° C. to about 80° C. Step 114 of neutralizing the intercalated layered aluminate adsorbent is performed for a predetermined amount of neutralization time, which can range between about 0.03125 hours and about 16 hours (and any range or value therebetween, including without limitation the values shown in Table 2 and the ranges therebetween), and more particularly, from between about 0.25 hours and about 1 hour. In one embodiment, the neutralization time is less than 2 hours.

TABLE 2
Neutralization Time and Temperatures.

| | Temperature (° C.) | | | | | | | | | |
|---|---|---|---|---|---|---|---|---|---|---|
| | 115 | 105 | 95 | 85 | 75 | 65 | 55 | 45 | 35 | 25 |
| Time | 0.03125 | 0.0625 | 0.125 | 0.25 | 0.5 | 1 | 2 | 4 | 8 | 16 |
| (Hours) | | | | | | | | | | |

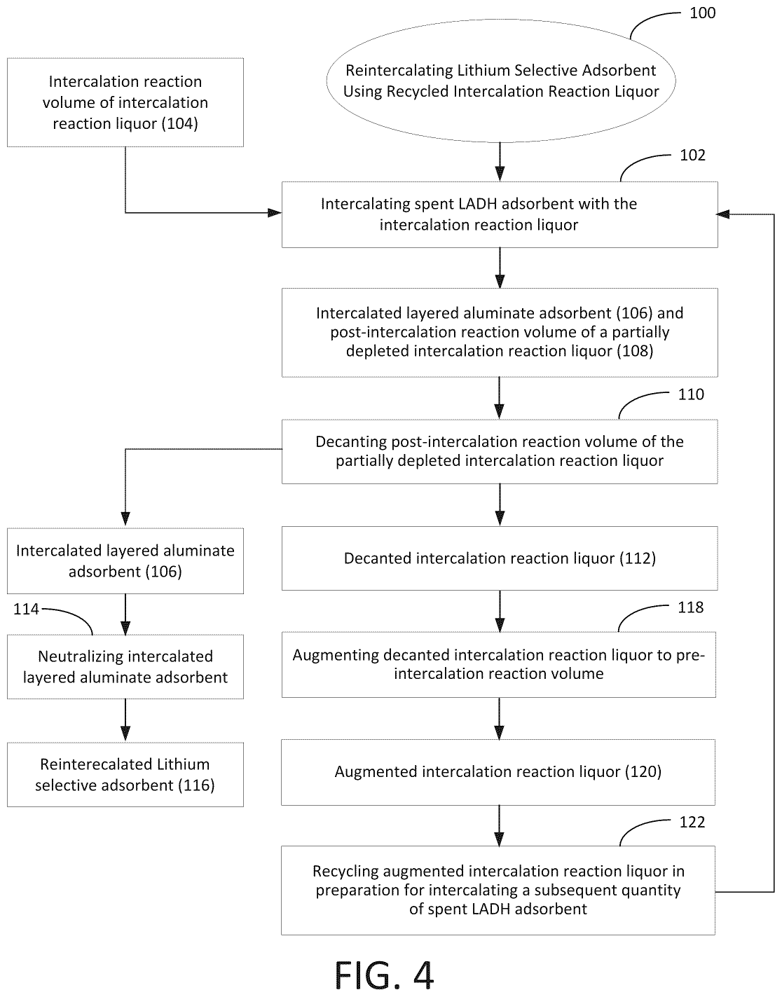

As exemplified in FIG. 4, the process 100 can include recycling the intercalation reaction liquor. In this embodiment, the post-intercalation reaction volume of the partially depleted intercalation reaction liquor 108 is decanted from the intercalated layered aluminate adsorbent 106 (step 110) to obtain a decanted intercalation reaction liquor 112. The decanted intercalation reaction liquor 112 is augmented (step 118) by adding a makeup volume to reconstitute the pre-intercalation reaction volume of the intercalation reaction liquor and to obtain an augmented intercalation reaction liquor 120. It will be appreciated that step 118 may occur before, after, or simultaneously with step 114. The makeup volume includes a makeup brine, a makeup lithium salt, a makeup alkali, or a mixture thereof. Suitable brines, lithium salts, and alkalis for augmenting the decanted intercalation reaction liquor in step 118 include those that are suitable for the intercalating step (step 102). The makeup brine, the makeup lithium salt, and/or the makeup alkali in step 118 may have the same or different components as the brine, the lithium salt, and the alkali used in step 102. Without limitation, the makeup brine may be NaCl, NaBr, NaNO₃, KCl, KBr, or a mixture thereof, and other dilute brines preferably containing a majority of chloride salts; the makeup lithium salt may be LiCl, LiNO₃, LiBr, LiOH, or a mixture thereof; and the makeup alkali may be KOH, NaOH, LiOH, or a mixture thereof. In one non-limiting embodiment, the makeup brine is NaCl, the makeup lithium salt is LiCl, and the makeup alkali is NaOH. In another non-limiting embodiment, the makeup lithium salt and the makeup alkali are both LiOH, where the makeup brine is optionally KCl.

The augmented intercalation reaction liquor 120 is recycled (step 122) in preparation for intercalating a subsequent quantity of alumina-based adsorbent precursor or spent LADH adsorbent (i.e., step 102 is repeated using the augmented intercalation reaction liquor 120 in place of the intercalation reaction liquor 104). This recycling may involve filtering the augmented intercalation reaction liquor 120, if necessary, prior to intercalating the subsequent quantity of alumina-based adsorbent precursor or spent lithium selective adsorbent. In one embodiment, steps 102, 110, 114, 118, and 122 are successively repeated until the intercalation reaction liquor is fully depleted or contains excess residual alumina such that the reaction no longer produces high-quality LADH adsorbents. In other non-limiting embodiments, steps 102, 110, 114, 118, and 122 are successively repeated up to about seven (7) times, up to about five (5) times, or up to about three (3) times.

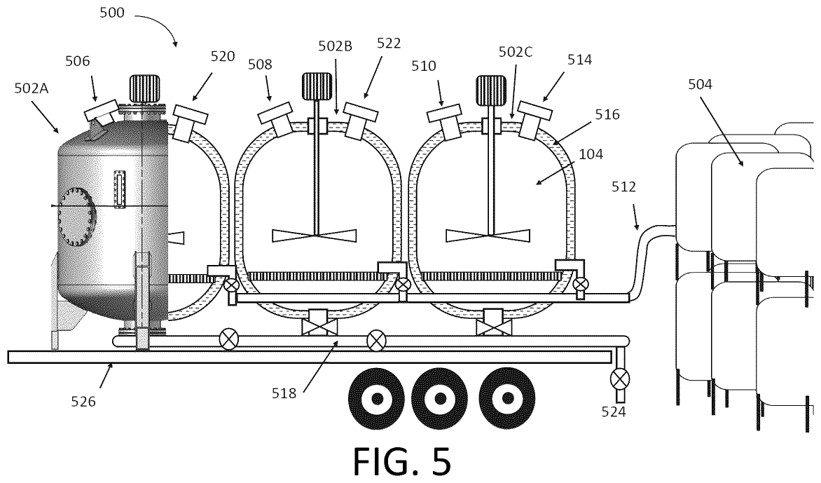

As noted above, the inventive reintercalation process 100 can be performed at a chemical regeneration facility or, as noted above, in situ, for example, on-site at a lithium extraction facility in an intercalation circuit 500 (FIG. 5). The circuit 500 includes a plurality of reactor vessels 502A, 502B, 502C configured to fluidly connect to a direct lithium extraction (“DLE”) vessel array 504 containing a LADH adsorbent. The reintercalation circuit 500 can vacuum transfer spent adsorbent from the DLE vessel array 504 to the reactor vessels 502A and 502B using one or more of vacuums 506, 508, 510, and an adsorbent transfer pathway 512. The intercalation reaction liquor 104 is prepared as described above in the reactor vessel 502C using a chemical addition port 514 to introduce chemical components. The reactor vessel 502C includes a heating jacket 516 to maintain the desired intercalation temperature, and the heated intercalation reaction liquor is transferred under vacuum to the reactor vessels 502A and 502B using an intercalation liquor transfer pathway 518. The inventive process intercalates the spent LADH adsorbent in the reactor vessels 502A and 502B with the intercalation reactor liquor 104 transferred from the reactor vessel 502C at a desired intercalation temperature and intercalation time (e.g., 95° C. for 3 hours). After reintercalating the spent adsorbent, the partially depleted intercalation reaction liquor 108 in the reactor vessels 502A and 502B is transferred back to the reaction vessel 502C using the intercalation liquor transfer pathway 518, where the partially depleted intercalation reaction liquor 108 can be augmented with lithium salts and alkali under heating and mixing to obtain an augmented intercalation reaction liquor 120. The reintercalated LADH adsorbent in the reactor vessels 502A and 502B is neutralized using an appropriate acid introduced using the chemical addition port 520, chemical addition port 522, or both and then vacuum transferred back to the DLE vessel array 504 using the adsorbent transfer pathway 512. The inventive process 100 can be continuously repeated such that additional volumes of spent LADH adsorbent are vacuum transferred from the DLE vessel array 504 to the reactor vessels 502A and 502B, and then the augmented intercalation reaction liquor 120 in the reactor vessel 502C is recycled to the reactor vessels 502A and 502B to reintercalate the LADH adsorbent. When the process is complete, the intercalation reaction liquor is routed through drain 524 for storage and subsequent reuse or disposal.

As exemplified in FIG. 5, the reintercalation circuit 500 can be modular and/or mounted on a mobile unit 526 to access resources, such as in a lithium extraction plant that requires a skid or mobile unit or in a remote lithium resource field, pipeline exchange, or storage hub. The reactor vessels 502A, 502B, 502C can be mounted on the mobile unit 526.

The inventive reintercalation process can also be used in situ within a SMB circuit for selective recovery of lithium from a feedstock solution. The SMB circuit includes a series of sequential steps in a cyclic process. The SMB circuit has a plurality of adsorption beds or columns, each containing a lithium selective adsorbent. The lithium selective adsorbent in the adsorbent beds can be any of the LADH forms known in the art. The adsorption beds are sequentially subjected to individual process zones as part of the SMB circuit. Each of the process zones includes one or more of the adsorbent beds configured in parallel, in series, or in combinations of parallel and series, flowing either in up-flow or down-flow modes.

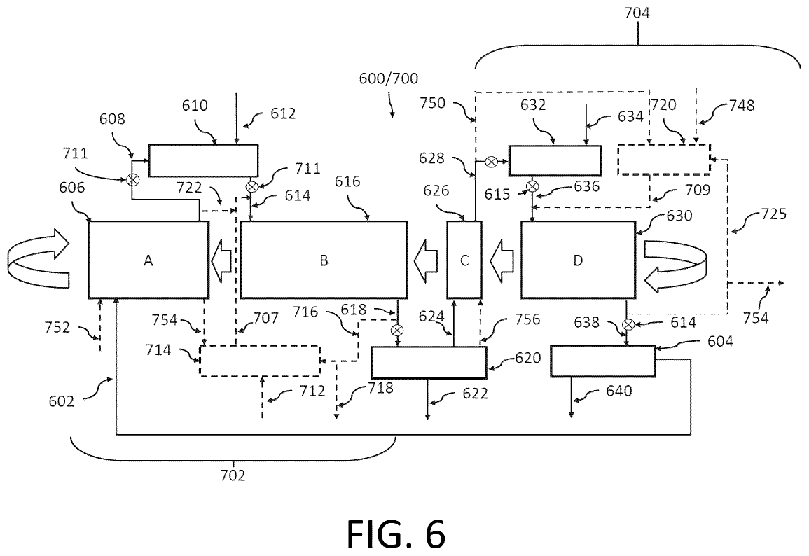

As exemplified in FIG. 6, the SMB circuit is configured as a continuous countercurrent adsorption and desorption (“CCAD”) circuit 600. Fluid flow through the CCAD circuit 600 is controlled by pumping flow rates and/or predetermined rotating or indexing of a central multi-port valve system, of the adsorbent beds, or both, creating a process where the adsorption beds continually cycle through the individual process zones. The CCAD circuit 600 includes a displacement zone A, an adsorption loading zone B, a strip displacement zone C, and a lithium product strip zone D. The displacement zone A is positioned upstream with respect to fluid flow of the loading zone B where lithium is adsorbed on one or more loading adsorbent beds or columns containing the lithium selective adsorbent.

A portion of high lithium concentration product eluate 602 is pumped from a lithium product vessel 604 in the lithium product strip zone D to an adsorbent bed(s) 606 in the displacement zone A. The elution volume of high lithium concentration product eluate 602 drawn from the lithium product strip zone D is at least enough to displace one adsorbent bed void lithium-bearing fraction 608 during an index time (the time interval between rotary valve indexes) of a single bed in the strip displacement zone D from the adsorbent bed(s) 606 to a combined feedstock vessel 610 in the displacement zone A.

A source of raw feedstock solution 612 is supplied to the combined feedstock vessel 610 and commingled with the displaced lithium-bearing fraction 608 to produce a combined feedstock solution 614. The combined feedstock solution 614 is pumped from the combined feedstock vessel 610 to an adsorbent bed(s) 616 in the adsorption loading zone B with a predetermined contact time sufficient to completely or almost completely load or exhaust the lithium selective adsorbent in the adsorbent bed(s) 616. The loading zone B is sized such that under the steady-state operation of the CCAD process/circuit 600, the complete lithium adsorption mass transfer zone is captured within the loading zone B. The lithium-depleted raffinate 618 exiting the loading zone B is sent to a depleted raffinate vessel 620. The steady-state operation achieves maximum lithium loading without significant lithium leaving with the lithium-depleted raffinate 618 as tails.

A portion of the lithium-depleted raffinate 622 is pumped from the vessel 620 to be returned to the brine aquifer, e.g., via reinjection, and another portion of the raffinate 624 is pumped from the vessel 620 to an adsorbent bed(s) 626 in the strip displacement zone C to displace latent eluate solution 628, which is carried forward as entrained fluid within the adsorbent bed 626 transitioning from the strip displacement zone C into an adsorbent bed(s) 630 in the lithium product strip zone D in the cyclic process, back to the inlet of the lithium product strip zone D. The elution volume of the displacement raffinate 624 drawn from the vessel 620 to displace the latent eluate solution 628 to a lithium product strip vessel 632 is at least enough to displace one adsorbent bed void fraction 628 during the rotary valve index time in the strip displacement zone C.

A lithium strip solution makeup 634 can be fluidly connected to the lithium product strip vessel 632. An eluant (lithium strip solution) 636 is pumped from the lithium product strip vessel 632 countercurrent to the process zone advance (fluid flow is illustrated as right to left, while the process zone movement is illustrated as left to right) into an adsorbent bed(s) 630 in the lithium product strip zone D to produce an enhanced lithium product stream 638. The lithium strip solution 636 includes a low-concentration lithium product eluant (as neutral salts, generally lithium chloride) in water at a concentration from about 0 mg/kg to about 1000 mg/kg lithium and at temperatures of about 5° C. to about 100° C. The enhanced lithium product stream 638 is pumped from the adsorbent bed(s) 630 in the lithium product strip zone D to the lithium product vessel 604.

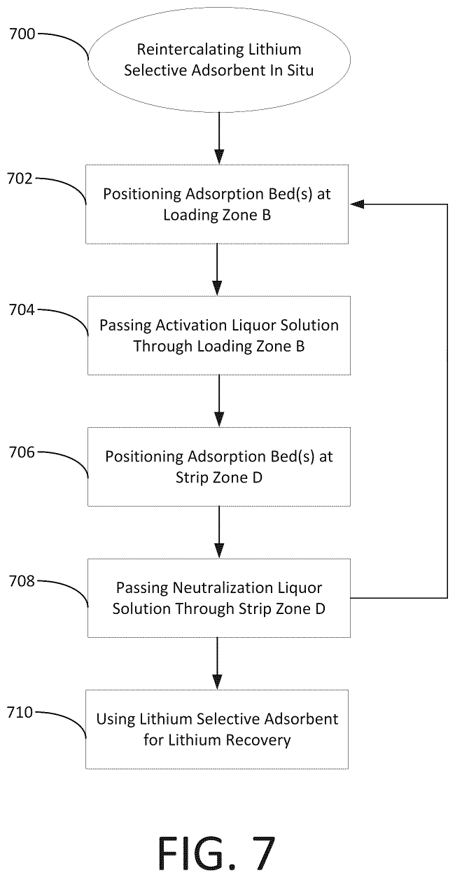

The lithium selective adsorbent used in the adsorbent beds 606, 616, 626, and 638 is deintercalated and spent over time. FIG. 7 illustrates an exemplary process flow diagram for an in situ regeneration process 700 to reintercalate the spent lithium selective adsorbent with an activation liquor solution, followed by neutralization. As exemplified, the inventive process 700 for intercalating the lithium selective adsorbent includes step 702 of positioning the adsorption bed(s) having the lithium selective adsorbent to be reintercalated at loading zone B. The placement of the adsorption bed(s) at loading zone B is facilitated by the cyclic SMB or CCAD process/circuit 600, which sequentially subjects the adsorption beds to each process zone. While the adsorption bed(s) 616 is positioned at loading zone B, step 704 passes the activation liquor solution through the loading zone B to reintercalate the lithium selective adsorbent. The adsorption bed(s) are then cycled to be positioned at strip zone D in step 706, and step 708 passes a neutralization liquor solution through the strip zone D to neutralize the lithium selective adsorbent. Steps 702 through 708 may be repeated numerous times, as required to completely or to almost completely regenerate (i.e., reintercalate and neutralize) the spent lithium selective adsorbent.

At the end of process 700, the lithium selective adsorbent is reintercalated to LADH and available for reuse in lithium recovery, as demonstrated by step 710. The in situ reintercalation process 700 may be repeated on the same lithium selective adsorbent in subsequent instances of deintercalation to realize significant savings in adsorbent loss and disposal costs. For example, the useful life of the lithium selective adsorbent can be at least tripled using at least two regenerations.

Turning back to FIG. 6, solid arrows represent traditional flow through the CCAD process/circuit 600, and dotted arrows represent an exemplary in situ reintercalation process/circuit 700 for lithium selective adsorbent within the CCAD process/circuit 600. The in situ regeneration process 700 involves reacting the spent lithium selective adsorbent with lithium salt, followed by neutralization using an appropriate acid. Accordingly, the in situ reintercalation process/circuit 700 includes an intercalation stage 702, in which the adsorbent bed(s) are intercalated, and a neutralization stage 704, in which the adsorbent bed(s) are neutralized following intercalation. The intercalation stage 702 occurs at the loading zone B, while the neutralization stage 704 occurs at the lithium product strip zone D. The intercalation stage 702 and the neutralization stage 704 operate simultaneously by cycling, respectively, an activation liquor solution 707 in and out of loading zone B and a neutralization liquor solution 709 in and out of lithium product strip zone D. The in situ reintercalation process/circuit 700 includes a plurality of air blowdowns 752, 754, 756 to prevent from cross contamination of the activation liquor solution 707 and the neutralization liquor solution 709 between the loading zone B and the lithium product strip zone D.

For the intercalation stage 702, the combined feedstock vessel 610 is isolated (e.g., by one or more check valves 711), such that the combined feedstock solution 614 is not pumped to the adsorbent bed(s) 616 in the adsorption loading zone B. The loading zone B is further isolated downstream from the depleted raffinate vessel 620. In this isolated state, the activation liquor solution 707 is provided for in situ reintercalation of the adsorbent bed(s) 616 within the loading zone B, where the activation liquor solution 707 includes lithium salt in a dilute brine.

To provide the activation liquor solution 707 to loading zone B, an activation liquor makeup 712 is first supplied to an activation liquor vessel 714. The activation liquor makeup 712 includes lithium salt, and suitable lithium salts include without limitation LiCl, LiNO₃, LiBr, LiOH, LiI, Li₂SO₄, and mixtures thereof. In an embodiment, the concentration of lithium salt in the activation liquor solution 707 is maintained between about 4,000 ppm and about 6,000 ppm (and any range or value therebetween). The intercalation stage 702 is generally performed with a stoichiometric excess or a stoichiometric amount of lithium salt in a stoichiometrically dilute brine to drive the intercalation reaction. In various embodiments, the lithium in the activation liquor solution 707 is in a ratio with aluminum in the lithium selective adsorbent ranging from about 1:1 to about 5:1 Li to Al (and any range or value therebetween).

Several suitable sources may supply the dilute brine for the activation liquor solution 707. In one instance, the lithium-depleted raffinate 618 exits the loading zone B from the CCAD process/circuit 600 but is prevented from entering the depleted raffinate vessel 620. The lithium-depleted raffinate 618 is split into a raffinate portion 716, which is diverted to the activation liquor vessel 714, and a second raffinate portion 718, which is diverted to a neutralization liquor vessel 720 for use in the neutralization stage 704. The raffinate portion 716 commingles with the activation liquor makeup 712 in the activation liquor vessel 714 and thereby acts as a brine source for the activation liquor solution 707. In another instance, the displaced lithium-bearing fraction 608 from the CCAD process/circuit 600 is prevented from entering the combined feedstock vessel 610 upstream of the loading zone B. Alternatively, or in addition to the raffinate portion 716, the fraction 608 is diverted from displacement zone A as a rerouted fraction 722 and provides a brine source for the activation liquor solution 707. Alternatively, or in addition to the raffinate portion 716 and/or the rerouted fraction 722, the activation liquor makeup 712 itself may include dilute brine alongside the lithium salt.

The activation liquor solution 707 enters loading zone B to intercalate the adsorbent bed(s) 616 for a predetermined contact period (e.g., a 12-minute step). After this intercalation reaction, the activation liquor solution 707 may be removed from loading zone B to exit the CCAD process/circuit 600.

For the neutralization stage 704, the lithium product strip zone D is isolated from the lithium product strip vessel 632 and from the lithium product vessel 604 (e.g., by a plurality of check valves 614, 615). In this isolated state, the neutralization liquor solution 709 is provided for in situ neutralization of the adsorbent bed(s) 630 within the lithium product strip zone D. To obtain the neutralization liquor solution 709, a neutralization acid makeup 748 having a suitable acid for the neutralization stage 704 is supplied to the neutralization liquor vessel 720. The acid can be hydrochloric, sulfuric, nitric, phosphoric, hydrobromic, perchloric, formic, acetic, or other suitable strong, mineral, sulfonic, or carboxylic acids, or a mixture thereof. The acid can have a concentration of between about 5% and about 100% (and any range or value therebetween) in the neutralization acid makeup 748.

To form the neutralization liquor solution 709, the neutralization acid makeup 748 is mixed with a brine. Several suitable sources may supply the brine for the neutralization liquor solution 709 before it enters the lithium product strip zone D. In one instance, the latent eluate solution 628 is prevented from entering the lithium product strip vessel 632 from the strip displacement zone C, and a rerouted eluate solution 750 is instead diverted from the strip displacement zone C to the neutralization liquor vessel 720 to supply the necessary brine. Alternatively, or in addition to the rerouted eluate solution 750, the second raffinate portion 718 from the intercalation stage 702 may be diverted to the neutralization liquor vessel 720 for contact with the neutralization acid makeup 748 therein. Alternatively, or in addition to the rerouted eluate solution 750 and/or the second raffinate portion 718, a spent neutralization liquor 725 having been used for a previous neutralization step contains residual brine and is routed to the neutralization liquor vessel 720, where it is contacted with the neutralization acid makeup 748. After neutralization of the lithium selective adsorbent, a spent acid/brine solution bleed 754 may be separated from the spent neutralization liquor 725 and removed from the CCAD process/circuit 600.

The intercalation stage 702 and the neutralization stage 704 continue until the spent lithium selective adsorbent is completely or almost completely reintercalated. In an embodiment, the lithium selective adsorbent is completely or almost completely reintercalated when the lithium selective adsorbent is between about 90% to about 100% reintercalated (and any range or value therebetween). The in situ reintercalation process/circuit 700 can be performed for a predetermined amount of regeneration time ranging between about 10 hours and about 12 hours (and any range or value therebetween) for a predetermined number of steps. In one embodiment where the predetermined amount of regeneration time is about 10 hours, a predetermined step rate for circulating the activation liquor solution 707 through loading zone B is set to 12-minute steps for 50 steps. Either a fresh volume or an augmented and recycled volume of the activation liquor solution 707 and/or the neutralization liquor solution 709 may be used for each of the steps. In an embodiment, an initial flow of the activation liquor solution 707 exits the loading zone B via the vessel reinject (at about 4 hours) before the in situ reintercalation process/circuit 700 is set to full recycle using the reagent vessel 730.

Generally, the same reaction conditions (i.e., temperature, pH, and lithium content, as applicable) are used for each step of the intercalation stage 702 and the neutralization stage 704 as discussed herein connection with other embodiments of the inventive reintercalation process. Within the in situ reintercalation process/circuit 700, these reaction conditions are continually monitored. During each step of the in situ reintercalation process/circuit 700, the temperature is maintained at a predetermined reintercalation temperature ranging from about 65° C. to about 75° C. (and any range or value therebetween). In an embodiment, the predetermined temperature is about 70° C. The in situ reintercalation process/circuit 700 generally operates under alkaline conditions, at a pH ranging from about 9 to about 9.6 (and any range or value therebetween). Toward the end of the in situ reintercalation process/circuit 300 (e.g., during the last 18 steps), the pH can instead range from about 5.4 to about 9.6 (and any range or value therebetween). As reintercalation of the lithium selective adsorbent proceeds, the pH will rise over time. In an embodiment, varying amounts of a pH modifier (e.g., HCl) are introduced to the activation liquor makeup 712 prior to entering the activation liquor vessel 614 to maintain the desired alkaline conditions. The concentration of lithium in the activation liquor solution 707 is maintained between about 4,000 ppm and about 6,000 ppm during each step. In an embodiment, the concentration of lithium salt is maintained at suitable levels by introducing additional lithium salt as necessary.

The inventive in situ reintercalation process/circuit 700 may be continuously or periodically repeated such that additional volumes of spent lithium selective adsorbent are intercalated and neutralized for reuse. The in situ reintercalation process/circuit 700 can operate alongside normal lithium recovery in the CCAD process/circuit 600. More particularly, processes for lithium recovery within the strip zone D, displacement zone A, and strip displacement zone C processes can operate as normal during the in situ reintercalation process/circuit 700.

### EXAMPLES

The process for reintercalating lithium selective adsorbents is further illustrated by the following examples, which are provided for the purpose of demonstration rather than limitation.

### Example 1—Reintercalation of Spent LADH Adsorbent

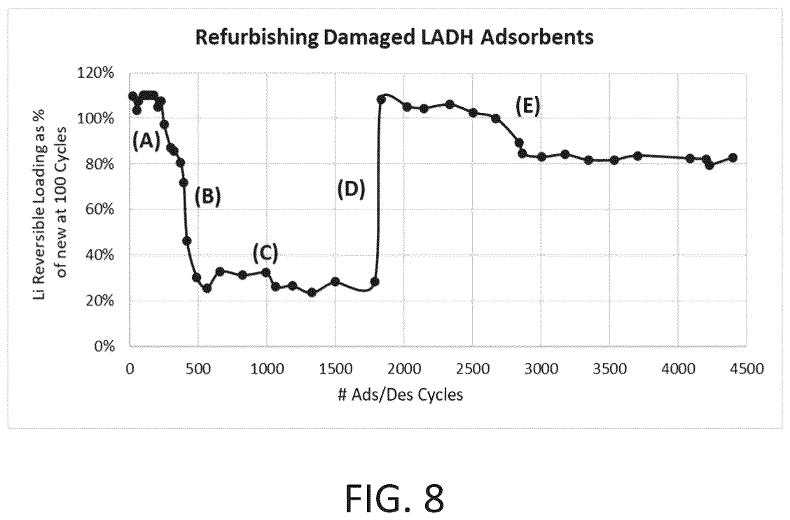

A sample of LADH lithium selective adsorbent was placed in an adsorption/desorption cycle testing apparatus and was challenged with adsorption and desorption of a lithium-bearing brine at 75° C. Each adsorption/desorption cycle took 1 hr to complete. As depicted in FIG. 8, for the first 244 cycles (A), the deintercalation water contained 100 ppm lithium (as LiCl). After 244 cycles (B), the sample was deintercalated with only water to induce a complete deintercalated condition. Over the subsequent 300 cycles, the adsorbent sample performance degraded to about 25% to about 30% of its original capacity. At 1500 cycles (C), normal deintercalation conditions were resumed with 100 ppm lithium as lithium chloride in the deintercalation water. The degradation of the sample from the adsorption/desorption cycles was not reversed by reintroducing lithium to the deintercalation solution.

Over the next 285 cycles, the sample was damaged by the complete deintercalation, which reverted the LADH of the adsorbent back to Gibbsite. At cycle 1785 (D), the sample was removed from the testing apparatus and regenerated by slurrying 25 mL of aged/damaged LADH adsorbent in 50 mL of 15% sodium chloride brine. Ten grams (10 g) of 50% NaOH and 10 g of LiCl were added to the slurry, and the slurry was gently stirred and placed in a 95° C. oven overnight. The partially depleted intercalation reaction liquor containing excess lithium salts was decanted away from the reintercalated layered aluminate adsorbent, and the pH of the decanted intercalation reaction liquor was measured to be 9.1. The decanted intercalation reaction liquor is saved for use in a subsequent conversion of aged/damaged adsorbent back to the active LADH form.

The decanted and regenerated adsorbent was slurried into 50 mL of fresh deintercalation solution (i.e., water with less than about 100 ppm Li as LiCl), heated to 75° C., and the pH of the slurry was 9.1. At 75° C., the regenerated adsorbent slurry was titrated slowly using a few milliliters of acetic acid (glacial or dilute) until the pH held between 5 and 6 for 30 min. The regenerated and titrated sample was rinsed with one volume of deintercalation solution and placed back in the cycle testing apparatus. The adsorption/desorption cycling was continued, and for the next 880 cycles (E), the adsorbent gave a like-new performance (e.g., greater than about 80% of its original capacity). A slight degradation was noted beginning at about 2650 cycles, suspected to be complete deintercalation damage due to a temporary pumping failure within the testing apparatus. The test was discontinued after 4400 cycles while the performance of the sample was still steady and at the like-new performance. At about 80% of the original adsorbent performance levels, the regenerated adsorbent retains intercalation and deintercalation performance within commercially acceptable ranges.

### Example 2—Lithium Salt Recycling During Adsorbent Reintercalation

A nearly 20-fold excess of lithium chloride is employed in converting the Gibbsite within the adsorbent precursor to its lithium-selective LADH form (the intercalation step). At the commercial scale, without recycling and reusing the lithium chloride in subsequent intercalation, the lost lithium chloride could be non-economical, and waste management could be costly. This Example outlines a process for recycling lithium chloride in subsequent intercalation of latent Gibbsite to LADH.

A fresh 25 mL sample of Gibbsite-bearing adsorbent precursor was activated to the LADH form using the recovered reaction liquor of Example 1. The 42.4 mL of saved reaction liquor from recycle 0 (Example 1) was augmented with 8.6 mL fresh 15% NaCl brine, returning it to its original 50 mL volume. The augmented intercalation reaction liquor was filtered to remove suspended solids, such as aluminum hydroxide and sodium salts, and then analyzed for lithium and free hydroxide. The lithium concentration was 26.5 g/L which is ˜81% of the original lithium concentration. The lithium concentration was returned to about 32.75 g/L by the addition of 1.9 g LiCl. In addition, 2 g of fresh 50% sodium hydroxide was added to reconstitute the alkali.

The 25 mL sample of Gibbsite-bearing precursor was treated in the same fashion as in Example 1 but using the recycled and augmented intercalation reaction liquor. As in Example 1, the slurry was gently mixed and placed in an oven at 95° C. for 6 hr. Then the slurry was again gently mixed, and the pH was taken and was measured at 9.8. As a general process, if the pH was less than 9.0, 1 g of 50% NaOH would be added to sufficiently increase the pH. Heating was continued for an additional 6 hr.

After cooling to 75° C., the partially depleted intercalation reaction liquor was decanted and saved for use in a subsequent recycle. The adsorbent sample created (recycle 1) was neutralized hot with titration by acetic acid, as in Example 1. The neutralized sample was placed in the cycle testing apparatus and run for 25 intercalation/elute cycles. The results after 25 cycles for recycle 1 were recorded, and the reversible lithium loading capacity for recycle 0 (Example 1) was taken as 100% for comparison to subsequent recycles using identical samples of Gibbsite-bearing precursor.

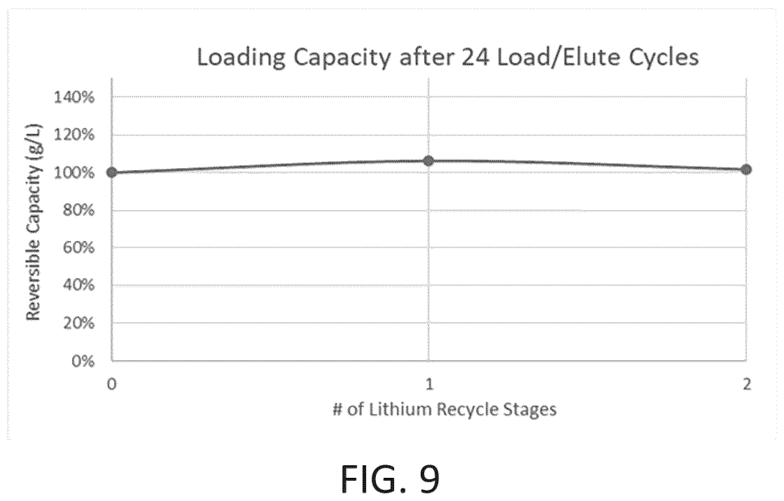

The same process was used in recycling the intercalation reaction liquor for 2 recycles of the liquor (recycle 1 and 2). The graph of FIG. 9 shows that these successive recycles successfully produced regenerated LADH adsorbents each time.

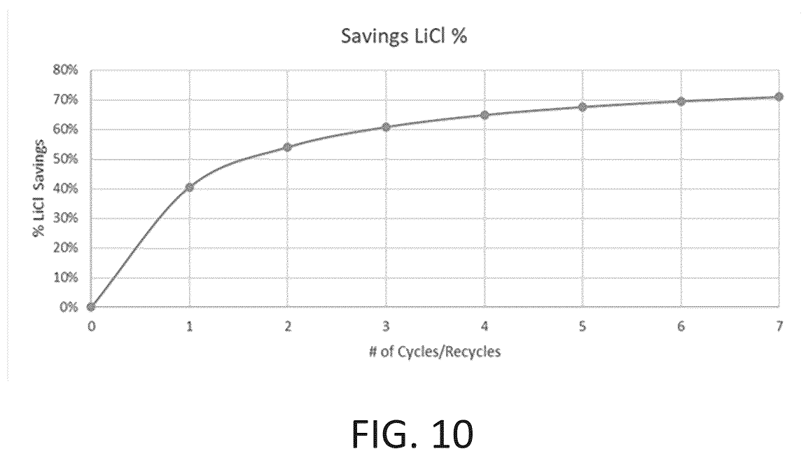

Example 2 demonstrates that with the large excess of LiCl employed in the regeneration/intercalation step, the high initial LiCl usage can be mitigated by successive recycling of the intercalation liquor. FIG. 10 graphically illustrates the lithium chloride savings with successive recycles.

### Example 3—Reintercalation of Over-Stripped LADH Adsorbent

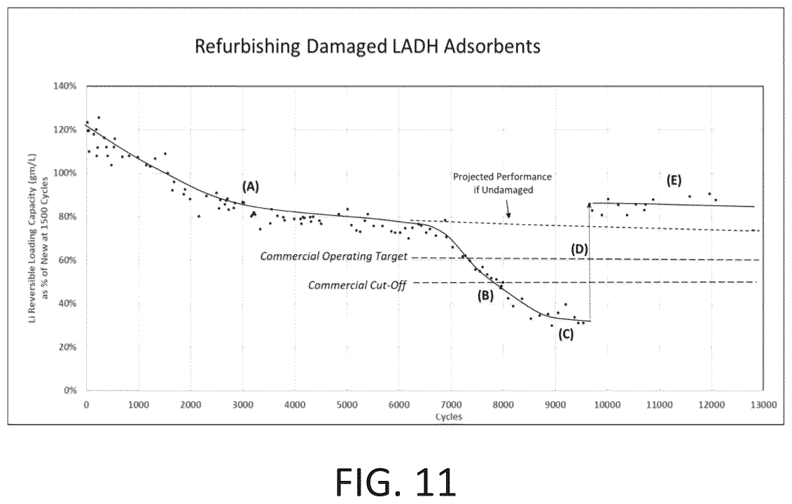

A fresh LADH lithium selective adsorbent sample was placed in an adsorption/desorption cycle testing apparatus and challenged with a lithium-bearing brine, adsorbed, and desorbed at 75° C. The intercalation cycle is generally 45-bed volumes over 45 min, and the deintercalation cycle is generally 12-bed volumes over 15 min. Each adsorption/desorption cycle takes 1 hr to complete. For this example, deintercalation was performed with 170 ppm lithium as LiCl in water. FIG. 11 graphically illustrates LADH adsorbent degradation and subsequent regeneration. Normal intercalation and deintercalation cycles were utilized for the first 6800 cycles (A). From 6800 cycles to 8500 cycles (B), the brine pump flow was significantly lower (about ½ the normal flow) due to a failing brine pump which went undiagnosed for several weeks. Returning to normal intercalation and deintercalation conditions at about 8500 cycles (C) did not recover the cycle testing performance of the sample. Due to the imbalance of brine intercalation to deintercalation ratio, the adsorbent sample was damaged as if completely deintercalated, as in Example 1. At about 9600 cycles (D), the sample was removed from the cycle testing apparatus and regenerated as in Example 1.

When placed back into the cycle testing apparatus, the adsorption/desorption cycling was continued. The regenerated adsorbent gave a like-new performance for the next 3000 cycles (E). The regenerated adsorbent performed above the commercial cut-off for more than 16000 intercalation/elute cycles, the commercial equivalent of over 5 years of operation.

### Example 4—Regeneration of LADH Adsorbent Using a LiOH Augmented Recycled Intercalation Liquor in a KCl Brine

In this Example, a sample of Gibbsite-bearing adsorbent precursor was divided into 100 mL portions and successively regenerated by recycling the intercalation reaction liquor. Specifically, Example 4 includes a first intercalation using an initial intercalation reaction liquor (Prep Cycle 1) and three subsequent cycles (Prep Cycles 2 through 4) using an augmented intercalation reaction liquor. Between each 100 mL intercalation, the reaction liquor's lithium and alkali content was augmented using LiOH·H₂O. The reaction media was 17% KCl brine solution. These changes ensure that there is no unwanted build-up of NaCl in the intercalation reaction liquor and that the lithium reagents are from a more commercially available source.

For the first intercalation, in a PVDF-coated beaker, 100 mL of Gibbsite adsorbent precursor was slurried in 100 mL 17% KCl brine. Nine grams (9 g) of LiCl and 10.6 g of LiOH·H₂O were added to the slurry, and the slurry was gently stirred until fully mixed. The beaker was loosely covered and placed in a 95° C. oven. After 6 hr, water was added to return the slurry to its original volume, and the beaker was then returned to the 95° C. oven for an additional 6 hr. After a total of 12 hr, the beaker was removed from the oven, and the volume was returned to its initial volume with water. The slurry was gently mixed and then poured into a 1-inch diameter Pyrex ion exchange column with a sintered PVDF straining disk. The intercalation reaction liquor was drained into a separate beaker for use in the next cycle. The flow was stopped when the reaction liquor was level with the top of the resin bed. To the column was added 50 mL (˜½ bed volumes) of water, and the water was slowly drained through the bed and out to the beaker. This process displaced the bulk of the reaction liquor to the beaker, and very little remained in the adsorbent sample. The adsorbent sample was then titrated to a lasting pH between about 5 and about 5.5 at about 70° ° C. to about 75° C. using acetic acid and saved for cycle testing. The sample was labeled “Prep Cycle 1.”

In a clean PVDF beaker, a second portion of 100 mL of Gibbsite-bearing adsorbent precursor was slurried with the regenerated intercalation reaction liquor from Prep Cycle 1, to which 0.6 g of LiOH·H₂O was added, and the slurry was stirred gently. The beaker was placed in a 95° C. oven, and the steps of Prep Cycle 1 were repeated. As in the case of Prep Cycle 1, the intercalation reaction liquor was recovered, and the adsorbent sample was titrated hot with acetic acid, labeled “Prep Cycle 2,” and saved for cycle testing.

Like the steps of Prep Cycle 2, in a clean PVDF beaker, a third 100 mL portion of Gibbsite-bearing adsorbent precursor was slurried with the regenerated intercalation reaction liquor from Prep Cycle 2, to which 5.0 g of LiOH·H₂O was added to augment the slurry with both lithium and alkali, and the slurry was stirred gently. The beaker was placed in a 95° C. oven, and the steps of Prep Cycle 2 were repeated. As in the case of Prep Cycles 1 and 2, the intercalation reaction liquor was recovered, and the adsorbent sample was titrated hot with acetic acid, labeled “Prep Cycle 3,” and saved for cycle testing.

The 100 mL sample of “Prep Cycle 4” was prepared by the same steps as Prep Cycle 3, except that the intercalation reaction liquor was augmented with just 4 g of LiOH·H₂O. The four-times-used intercalation reaction liquor was saved for future analysis, and the Prep Cycle 4 adsorbent sample was saved for cycle testing.

Cycle testing results for the four (4) samples (Prep Cycles 1 to 4) demonstrated that the process yields a highly active adsorbent for all four (4) cycles using the augmented recycled intercalation liquor (see Table 3). This process is highly efficient in lithium consumption compared to the base case where 20 g of LiCl and 10 g NaOH would be employed for each intercalation and then discarded.

TABLE 3
Cycle Testing Results Example 4

| Sample | % Li capacity |
|---|---|
| Gibbsite Precursor | 5% |
| Prep Cycle 1 | 100% |
| Prep Cycle 2 | 100% |
| Prep Cycle 3 | 98% |
| Prep Cycle 4 | 95% |

After 270 Intercalation/Deintercalation Cycles

Based on the limited availability of LiCl, commercial production of large quantities of lithium-selective adsorbents can proceed more cost-effectively and efficiently using the process of Example 4. As shown in FIG. 10, by Prep Cycle 2, overall lithium savings reached 50%, and by Prep Cycle 4, lithium savings reached over 63%. In addition, by Prep Cycle 4, LiCl use was reduced by 89% compared to the base case.

### Example 5—Regeneration of LADH Adsorbent Using a LiOH Augmented Recycled Intercalation Liquor in a NaCl Brine

In Example 5, a sample of Gibbsite-form adsorbent precursor was divided into 150 mL portions and regenerated successively by recycling the intercalation liquor. Between each 150 mL intercalation, the reaction liquor's lithium and alkali content was augmented using LiOH·H₂O like in Example 4, but in Example 5, the reaction media comprised 22% NaCl brine. The use of LiOH·H₂O rather than NaOH assures there is no unwanted build-up of NaCl in the reaction liquor and that the lithium reagents are from a more commercially obtainable source.

For the first activation, Prep Cycle 1, in a PVDF-coated beaker, 150 mL of Gibbsite adsorbent precursor was slurried in 100 mL 22% NaCl brine. Some LiCl was added to Prep Cycle 1 to increase the initial lithium concertation to the desired excess in the intercalation liquor, beyond the level provided by the alkaline LiOH alone. For subsequent Prep Cycles (2-5), the intercalation liquor was augmented by LiOH·H₂O alone. For subsequent cycles, the LiOH·H₂O provided both, the lithium and alkali requirements. Fifteen grams (15 g) of LiCl and 7.5 g of LiOH·H₂O were added to the slurry and stirred until fully mixed. The beaker was placed on a temperature-controlling hotplate apparatus with a mechanical stirrer, loosely covered, and stirred at 95° C. to 98° C. for 3 hr, adding water if needed to maintain the volume. After 3 hr, the beaker was removed from the hotplate apparatus, and the adsorbent slurry was gently mixed and then poured into a 1-inch diameter Pyrex ion exchange column with a sintered PVDF straining disk. The reaction liquor was drained into a separate beaker for use in the next cycle. The flow was stopped when the reaction liquor was level with the top of the resin bed. To the column was added 75 mL (˜½ bed volumes) of 22% NaCl brine, which was slowly drained through the bed, and out to the beaker. This displaced the bulk of the reaction liquor to the beaker and very little remained in the adsorbent sample. The sample was titrated to a lasting pH between 5 and 5.5 at 70° C. to 75° C. using acetic acid and saved for cycle testing. The sample was labeled “Prep Cycle 1”.

In a clean PVDF beaker, a second portion of 150 mL of Gibbsite adsorbent precursor was slurried with the recovered intercalation reaction liquor for Prep Cycle 1, to which 7.5 g of LiOH·H₂O was added and the heating steps of Prep Cycle 1 were repeated. As in the case of Prep Cycle 1, the intercalation reaction liquor was recovered and the adsorbent sample was titrated at 70° ° C. to 75° C. to lasting pH between 5.0 and 5.5 using acetic acid, labeled “Prep Cycle 2” and saved for cycle testing.

Prep Cycle 3-5 were carried out in the same way as Prep Cycle 2, each cycle augmented with 7.5 g LiOH·H₂O. As in the case of Prep Cycles 1 and 2, the intercalation liquor was recovered and the adsorbent sample was titrated hot with acetic acid, labeled “Prep Cycle 3, Prep Cycle 4, and Prep Cycle 5,” and saved for cycle testing.

As shown in Table 4, cycle testing results for the four (4) samples, Prep Cycle 1-5 indicate that this process resulted in highly active adsorbent for all five (5) cycles using the augmented recycled intercalation liquor. This process is highly efficient in lithium consumption when compared to the base case noted above. By Prep Cycle 5, the overall lithium savings was over 65% in comparison to the base case, taking the lithium demand from 7.5 mol/L down to 2.5 mol/L. There was negligible degradation in adsorbent performance over the five (5) cycles, and no precipitation or crystallization problems were observed, eliminating the need for interstage filtration. Recycling of the intercalation reaction liquor should be possible far beyond the fifth cycle, further eliminating a sizable portion of the lithium from the waste streams.

TABLE 4
Cycle Testing Results Example 5

| Sample | % Li capacity |
|---|---|
| Gibbsite Precursor | 5% |
| Prep Cycle 1 | 100% |
| Prep Cycle 2 | 94% |
| Prep Cycle 3 | 103% |
| Prep Cycle 4 | 97% |
| Prep Cycle 5 | 97% |

After 270 Intercalation/Deintercalation Cycles

### Example 6—In Situ Reintercalation of Spent LADH Adsorbent

A sample of LADH lithium selective adsorbent was damaged by excessive deintercalation, which reverted the LADH of the adsorbent back to Gibbsite. One hundred milliliters (100 mL) of the excessively deintercalated LADH adsorbent (0.5 g/L reversible lithium capacity against 250 mg/kg geothermal brine) was introduced in a 2.5 cm glass column with a circulating jacket at 74° C. In a heated 74° ° C. feed pot, 7.2 grams (g) of LiOH H₂O and 7.2 g of LiCl (˜6 lbs LiX/cuft) were added to 1,200 mL of a 20% sodium chloride solution. The initial pH of the resulting regeneration liquor was measured to be 9.8, and an initial Li concentration of 1,950 ppm was determined using a photoelectric flame photometer. The regeneration liquor was continuously circulated up-flow through the deintercalated LADH adsorbent for 2 hours at 78 mL per minute (or 3.78 gallons per minute per square foot (gpm/sf)). The final pH of the regeneration liquor was measured to be 6.3, and the lithium concentration had dropped to 1,430 ppm.

To determine the degree of reintercalation achieved in the in situ regeneration, the regeneration liquor was drained to the top of the adsorbent bed, and a stripping solution of deionized water containing 140 ppm Li (855 ppm LiCl) was passed through the adsorbent bed at 20 mL per minute at 74° C. The first 50 mL (½ bounded variation (BV)) was discarded as entrained reaction liquor, and the following 600 mL was collected and analyzed for lithium content by flame photometry. The concentration of lithium was measured to be 680 ppm. After subtracting the 140 ppm of striping solution, the difference was 540 ppm, which corresponds to a lithium content of 324 mg, indicating a regenerated lithium capacity of 3.34 g/L.

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted as a range whose lower limit is 25 and whose upper limit is 100. Additionally, it should be noted that where a range is given, every possible subrange or interval within that range is also specifically intended unless the context indicates the contrary. For example, if the specification indicates a range of 25 to 100, such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only, and decimal and fractional values (e.g., 46.7-91.3) should also be understood to be intended as possible subrange endpoints unless specifically excluded.

It should be understood that the exemplary embodiments described above should be considered in a descriptive sense only and not for purposes of limitation. Descriptions of features or aspects within these embodiments should typically be considered as available for other similar features or aspects in other embodiments.

While one or more embodiments have been described with reference to the figures, it will be understood by those of ordinary skill in the art that various changes in form and details may be made therein without departing from the scope of the inventive concept as defined by the following claims.

What is claimed is:

1. A process for reintercalating a spent lithium selective adsorbent, the process comprising the steps of:
a. intercalating an initial quantity of the spent lithium selective adsorbent with lithium under alkaline conditions at a predetermined intercalation temperature using a pre-intercalation reaction volume of an intercalation reaction liquor to produce an intercalated layered aluminate adsorbent and a post-intercalation reaction volume of a partially depleted intercalation reaction liquor; and
b. neutralizing the intercalated layered aluminate adsorbent under acidic conditions at a predetermined neutralization temperature to produce a reintercalated lithium selective adsorbent.

2. The process of claim 1, wherein the intercalation temperature is between about 25° C. and about 125° C.

3. The process of claim 2, wherein the intercalation temperature is between about 85° C. and about 105° C.

4. The process of claim 3, wherein the intercalation temperature is greater than 100° C. to about 105° C.

5. The process of claim 1, wherein the alkaline conditions comprise a pH from about 7 to about 13.

6. The process of claim 5, wherein the pH is between about 9 and about 12.

7. The process of claim 1, wherein the intercalation reaction liquor comprises a lithium salt and an alkali in a dilute brine.

8. The process of claim 7, wherein the lithium salt comprises LiCl, LiNO₃, LiBr, LiOH, or a mixture thereof.

9. The process of claim 8, wherein the lithium salt is LiCl or LiOH.

10. The process of claim 7, wherein the lithium salt in the intercalation reaction liquor has a concentration ratio of about 1:1 to about 5:1 Li to Al.

11. The process of claim 7, wherein the alkali comprises an alkali hydroxide, an alkaline earth metal hydroxide, a strong base, a monoacid base, ammonia, or a mixture thereof.

12. The process of claim 11, wherein the alkali comprises KOH, NaOH, LiOH, or a mixture thereof.

13. The process of claim 7, wherein the alkali has a concentration between about 1 and about 3 mol of the alkali per mol of Al(OH)₃ in the intercalated layered aluminate adsorbent.

14. The process of claim 13, wherein the alkali has a concentration greater than 1 to about 3 mol of the alkali per mol of Al(OH)₃ in the intercalated layered aluminate adsorbent.

15. The process of claim 13, wherein the alkali has a concentration between about 1 and about 1.5 mol of the alkali per mol of Al(OH)₃ in the intercalated layered aluminate adsorbent.

16. The process of claim 15, wherein the alkali has a concentration greater than 1 to about 1.5 mol of the alkali per mol of Al(OH)₃ in the intercalated layered aluminate adsorbent.

17. The process of claim 7, wherein the lithium salt is LiOH, and the alkali is LiOH.

18. The process of claim 7, wherein the brine comprises a majority of chloride salts.

19. The process of claim 7, wherein the brine comprises NaCl, NaBr, NaNO₃, KCl, KBr, or a mixture thereof.

20. The process of claim 7, wherein the brine is NaCl, the lithium salt is LiCl, and the alkali is NaOH.

21. The process of claim 7, wherein the brine is NaCl, the lithium salt is LiOH, and the alkali is LiOH.

22. The process of claim 1, wherein the step a. of intercalating the initial quantity of the spent lithium selective adsorbent further comprises intercalating the initial quantity of the spent lithium selective adsorbent by heating to the predetermined intercalation temperature for a predetermined amount of intercalation time between about 0.375 hours and about 390 hours.

23. The process of claim 22, wherein the predetermined amount of intercalation time is greater than 100 hours to about 390 hours.

24. The process of claim 23, wherein the predetermined amount of intercalation time is between about 1.5 hours and about 6 hours.

25. The process of claim 1, wherein the neutralization temperature is between about 25° C. and about 115° C.

26. The process of claim 25, wherein the neutralization temperature is between about 65° C. and about 80° C.

27. The process of claim 26, wherein the neutralization temperature is greater than 70° C. to about 80° C.

28. The process of claim 1, wherein the acidic conditions comprise a pH from about 4.5 to about 7.

29. The process of claim 28, wherein the pH is between about 5 and about 5.8.

30. The process of claim 29, wherein the pH is greater than 5 to about 5.8.

31. The process of claim 1, wherein the acidic conditions comprise using an acid, and wherein the acid is a strong acid, a mineral acid, a sulfonic acid, a carboxylic acid, or a mixture thereof.

32. The process of claim 31, wherein the acid is hydrochloric acid, sulfuric acid, nitric acid, phosphoric acid, hydrobromic acid, perchloric acid, formic acid, acetic acid, or a mixture thereof.

33. The process of claim 32, wherein the acid is acetic acid.

34. The process of claim 31, wherein the acid has a concentration of between about 5% and about 100%.

35. The process of claim 1, wherein the step of neutralizing the intercalated layered aluminate adsorbent further comprises neutralizing the intercalated layered aluminate adsorbent for a predetermined amount of neutralization time.

36. The process of claim 35, wherein the neutralization time is between about 0.03125 hours and about 16 hours.

37. The process of claim 36, wherein the neutralization time is between about 0.25 hours and about 1 hour.

38. The process of claim 36, wherein the neutralization time is less than 2 hours.

39. The process for claim 1 further comprising the steps of:
a. intercalating the initial quantity of the spent lithium selective adsorbent with the lithium under the alkaline conditions at the predetermined intercalation temperature using the pre-intercalation reaction volume of the intercalation reaction liquor to produce the intercalated layered aluminate adsorbent and the post-intercalation reaction volume of the partially depleted intercalation reaction liquor;
b. decanting the post-intercalation reaction volume of the partially depleted intercalation reaction liquor from the intercalated layered aluminate adsorbent to obtain a decanted intercalation reaction liquor;
c. neutralizing the intercalated layered aluminate adsorbent under the acidic conditions at the predetermined neutralization temperature to produce the lithium selective adsorbent;
d. augmenting the decanted intercalation reaction liquor by adding an makeup volume to reconstitute the pre-intercalation reaction volume and obtain an augmented intercalation reaction liquor; and
e. recycling the augmented intercalation reaction liquor for intercalating a subsequent quantity of the adsorbent precursor according to step a.

40. The process of claim 39, wherein the makeup volume comprises a makeup brine, a makeup lithium salt, a makeup alkali, or a mixture thereof.

41. The process of claim 40, wherein the makeup brine comprises NaCl, NaBr, NaNO₃, KCl, KBr, or a mixture thereof.

42. The process of claim 40, wherein the makeup lithium salt comprises LiCl, LiNO₃, LiBr, LiOH, or a mixture thereof.

43. The process of claim 40, wherein the makeup alkali comprises KOH, NaOH, LiOH, or a mixture thereof.

44. The process of claim 40, wherein the makeup lithium salt is LiOH, and the makeup alkali is LiOH.

45. The process of claim 40, wherein the makeup brine is NaCl, the makeup lithium salt is LiCl, and the makeup alkali is NaOH.

46. The process of claim 40, wherein the makeup brine is KCl, the makeup lithium salt is LiOH, and the makeup alkali is LiOH.

47. The process of claim 39, wherein the step of recycling the augmented intercalation reaction liquor further comprises the step of filtering the augmented intercalation reaction liquor.

48. The process of claim 39 further comprises successively repeating steps a. through e. until the intercalation reaction liquor is fully depleted or contains excess residual alumina such that the reaction no longer produces the lithium selective adsorbent.

49. The process of claim 48 further comprises successively repeating steps a. through e. between seven times and about three times.

50. The process of claim 49 further comprises successively repeating steps a. through e. up to about three times.

51. A process for in situ reintercalation of a spent lithium selective adsorbent, the process comprising the steps of:
a. intercalating one or more adsorbent beds or columns having the spent lithium selective adsorbent at an adsorption loading zone; and
b. neutralizing the one or more adsorbent beds or columns at a lithium product strip zone.

52. The process of claim 51, wherein step a. of intercalating the one or more adsorbent beds or columns further comprises positioning one or more adsorbent beds or columns having the spent lithium selective adsorbent at an adsorption loading zone, and isolating the adsorption loading zone from an upstream combined feedstock vessel and from a downstream depleted raffinate vessel.

53. The process of claim 51, wherein the step a. of intercalating the one or more adsorbent beds or columns further comprises intercalating one or more adsorbent beds or columns having the spent lithium selective adsorbent at an adsorption loading zone for a predetermined amount of reintercalation time at a predetermined reintercalation temperature and under alkaline conditions, and introducing an activation liquor solution at the adsorption loading zone.

54. The process of claim 53, wherein the predetermined amount of reintercalation time ranges between about 10 hours and about 12 hours, wherein the predetermined reintercalation temperature is between about 65° C. and about 75° C., and wherein pH for the alkaline conditions ranges between about 5.4 and about 9.6.

55. The process of claim 53, wherein the activation liquor solution comprises lithium salt and brine, wherein the lithium salt is LiCl, LiNO₃, LiBr, LiOH, LiI, Li₂SO₄, or a mixture thereof, and wherein the brine comprises NaCl, NaBr, NaNO₃, KCl, KBr, or a mixture thereof. makeupmakeupmakeupmakeup

56. The process of claim 51, wherein the step b. of neutralizing the one or more adsorbent beds or columns further comprises introducing a neutralization liquor solution at the lithium product strip zone.

57. The process of claim 56, wherein the neutralization liquor solution comprises an acid and a brine, wherein the acid is hydrochloric acid, sulfuric acid, nitric acid, phosphoric acid, hydrobromic acid, perchloric acid, formic acid, acetic acid, or a mixture thereof, and wherein the brine comprises NaCl, NaBr, NaNO₃, KCl, KBr, or a mixture thereof.

58. A circuit for in situ reintercalation of a spent lithium selective adsorbent, the circuit comprising:
a reagent vessel having a reagent solution, wherein the reagent solution comprises a lithium salt;
a brine vessel having a brine solution;
a simulated moving bed (“SMB”) circuit comprising an activation stage having an adsorption loading zone and a neutralization stage having a lithium product strip zone, wherein one or more adsorbent beds or columns having the spent lithium selective adsorbent cycle through the adsorption loading zone and the lithium product strip zone; and
a process pump configured to pump the reagent solution, the brine solution, or both to the SMB circuit.

59. The circuit of claim 58, wherein the lithium salt is LiCl, LiNO₃, LiBr, LiOH, LiI, Li₂SO₄, or a mixture thereof, and wherein the brine comprises NaCl, NaBr, NaNO₃, KCl, KBr, or a mixture thereof.

60. The circuit of claim 58, further comprising a plurality of check valves control fluid flow from the reagent vessel, the brine vessel, or both, and a heat exchanger upstream of the SMB circuit, wherein the heat exchanger provides temperature control for the activation liquor makeup.

61. The circuit of claim 58, wherein the reagent solution and the brine solution are combined to form an activation liquor makeup upstream from the process pump, and wherein the process pump moves the activation liquor makeup into an activation liquor vessel upstream from the adsorption loading zone and through the adsorption loading zone.

62. The circuit of claim 58, wherein the SMB circuit further comprises a neutralization liquor vessel upstream from the lithium product strip zone, wherein the neutralization liquor vessel contains a neutralization liquor solution, and wherein the neutralization liquor solution comprises an acid, wherein the acid is hydrochloric acid, sulfuric acid, nitric acid, phosphoric acid, hydrobromic acid, perchloric acid, formic acid, acetic acid, or a mixture thereof.

63. The circuit of claim 58, wherein the SMB circuit comprises a continuous countercurrent adsorption and desorption circuit (“CCAD”).
